(19) United States
(12) Patent Application Publication
(10) Pub. No.: US 2025/0296724 A1
(43) Pub. Date: Sep. 25, 2025

(54) WATER TANK

(71) Applicant: COWAY Co., Ltd., Gongju-si (KR)

(72) Inventors: Woo Jin JOO, Gongju-si (KR); Yong Yeon NOH, Gongju-si (KR); Kihong MIN, Gongju-si (KR); Won Hyuk LEE, Gongju-si (KR); Min Suk CHANG, Gongju-si (KR); Sang Bong JE, Gongju-si (KR); Gyeong Jong KIM, Gongju-si (KR)

(73) Assignee: COWAY Co., Ltd., Gongju-si (KR)

(21) Appl. No.: 19/082,323

(22) Filed: Mar. 18, 2025

(30) Foreign Application Priority Data
Mar. 19, 2024 (KR) 10-2024-0037568

(51) Int. Cl. B65D 1/42; B65D 1/26; B65D 43/02

(52) U.S. Cl. CPC B65D 1/42; B65D 1/26; B65D 43/0202; B65D 2543/00203; B65D 2543/00972

(57) ABSTRACT

A water tank is disclosed. According to one aspect of the present disclosure, a water tank may include: a tank body having a tank body space formed therein; a tank cover configured to cover the tank body space and be coupled to the tank body; a reinforcing member that is at least partially accommodated in the tank body space and is respectively coupled to the tank body and the tank cover to reinforce rigidity of the tank body or the tank cover; and a fastening part configured to couple the reinforcing member and the tank cover.

### CROSS-REFERENCE TO RELATED APPLICATION(S)

This application claims priority to and the benefit of Korean Patent Application No. 10-2024-0037568, filed on Mar. 19, 2024, the disclosure of which is incorporated herein by reference in its entirety.

### TECHNICAL FIELD

The present disclosure relates to a water tank, and more specifically to a water tank that is capable of preventing deformation due to the pressure of a fluid contained therein and capable of quantitative extraction.

### RELATED ART

A water purifier refers to a device that receives raw water from the outside, filters the same, and supplies the same to the outside. With the improvement of living standards, water purifiers are widely used not only in commercial facilities but also in general homes.

Recently, water purifiers that can heat or cool purified water as well as provide hot or cold water have been developed and utilized. Such water purifiers do not require a separate treatment process to adjust the temperature of discharged purified water to a desired temperature, and thus, user convenience can be improved.

A water purifier that can provide hot or cold water can be configured to include a tank for receiving purified water. The purified water introduced into the tank can be heated or cooled and then supplied to the outside according to the user's request.

Meanwhile, if purified water introduced into the tank is arbitrarily exposed to the outside, there is a risk of contamination of the purified water. To this end, the tank is configured to be sealed except for a part where purified water is introduced and another part where the introduced purified water is cooled or heated and then discharged.

Therefore, if purified water is introduced into the tank or purified water stored in the tank is discharged to the outside, pressure changes may inevitably occur inside the tank. As the inflow and outflow of purified water proceed, the outer wall of the tank surrounding the space inside the tank may be damaged by repeated expansion and contraction due to the pressure change.

In this case, it is difficult to reliably seal the inside of the tank, which may cause contamination of the stored purified water. Furthermore, there is also a concern that the tank may be damaged and the stored purified water may leak out randomly, thereby causing the water purifier to malfunction.

Accordingly, a method is required to prevent damage to the tank despite pressure changes inside the tank that accommodates purified water to be generated as hot or cold water.

Korean Patent Laid-Open Publication No. 10-2017-0022776 discloses an induction heating module. Specifically, it discloses an induction heating module that accommodates purified water in a space formed inside the first and second covers and heats the accommodated purified water through an induction heating module to generate hot water.

However, the water purifier disclosed in the above related art document only provides a method for preventing deformation of the shape of the water purifier main body. In other words, the related art document does not provide a method for preventing deformation of the shape of the water tank itself that receives purified water or reinforcing the rigidity of the water tank itself.

Korean Registered Patent Publication No. 10-1890055 discloses a pressure rise prevention device for a sealed cooling tank for a water purifier. Specifically, it discloses a pressure rise prevention device that is provided on one side of a sealed cooling tank and can prevent pressure from rising by adjusting the pressure of the sealed cooling tank.

However, the pressure rise prevention device for a sealed cooling tank for a water purifier disclosed in the above related art document only provides a method for adjusting a pressure formed inside the sealed cooling tank. In other words, the above related art document does not provide a method for reinforcing the rigidity of the cooling tank that receives purified water and preventing its shape from being deformed.

### RELATED ART DOCUMENTS

### Patent Documents

Korean Registered Patent Publication No. 10-2017-0022776 (Mar. 2, 2017)

Korean Registered Patent Publication No. 10-1890055 (Aug. 20, 2018)

### SUMMARY

The present disclosure has been devised to solve the above problems, and an object of the present disclosure is to provide a water tank having a structure that can prevent deformation due to the pressure of a fluid contained inside.

Another object of the present disclosure is to provide a water tank having a structure that can maintain a constant amount of fluid provided to the outside.

Still another object of the present disclosure is to provide a water tank having a structure that can prevent deformation without excessive structural changes.

Still another object of the present disclosure is to provide a water tank having a structure that can achieve the above objects without excessive increase in volume.

Still another object of the present disclosure is to provide a water tank having a structure that can minimize interference with other elements positioned in an installation space.

The problems of the present disclosure are not limited to the problems mentioned above, and other problems that are not mentioned will be clearly understood by those skilled in the art to which the present disclosure pertains from the description below.

According to an aspect of the present disclosure, provided is a water tank, including a tank body having a tank body space formed therein; a tank cover configured to cover the tank body space and be coupled to the tank body; a reinforcing member that is at least partially accommodated in the tank body space and is respectively coupled to the tank body and the tank cover to reinforce rigidity of the tank body or the tank cover; and a fastening part configured to couple the reinforcing member and the tank cover.

In this case, the water tank may be provided, wherein the tank body includes a tank body surface that surrounds the tank body space on one side opposite to the tank cover, and wherein the reinforcing member extends between the tank body surface and the tank cover and is respectively coupled to the tank body surface and the tank cover.

In addition, the water tank may be provided, wherein one end of an extension direction of the reinforcing member is fixedly coupled to the tank body surface.

In this case, the water tank may be provided, wherein the reinforcing member includes a reinforcing body accommodated in the tank body space, one end of which in an extension direction is coupled to the tank body surface; and a reinforcing head that is continuous with the other end of an extension direction of the reinforcing body, and is exposed to the outside of the tank body space and is arranged to face the tank body space with the tank cover interposed therebetween.

In addition, the water tank may be provided, wherein the tank cover includes a tank cover surface configured to cover the tank body space; and a tank cover penetration hole positioned inside the tank cover surface and formed through the extension direction of the reinforcing body, through which the reinforcing member is penetrated and coupled.

In this case, the water tank may be provided, wherein the tank cover includes a tank cover recessed part formed to be recessed on the tank cover surface toward the tank body space; and a tank cover boss part positioned in the tank cover recessed part and formed to protrude in a direction opposite to the tank body space.

In addition, the water tank may be provided, wherein the reinforcing member includes an O-ring member coupling part that is continuous with the other end of the extension direction of the reinforcing body and penetrates the tank cover; a nut member coupling part that is continuous with the O-ring member coupling part and is coupled to the fastening part; and a snap ring member coupling part that is continuous with the nut member coupling part and the reinforcing head, respectively, and is coupled to the fastening part.

In this case, the water tank may be provided, wherein the fastening part is through-coupled to the O-ring member coupling part, and includes an O-ring member configured to seal between the O-ring member coupling part and the tank cover.

In addition, the water tank may be provided, wherein the fastening part includes a washer member that is through-coupled to the O-ring member coupling part and is disposed to face the tank body space with the tank cover interposed therebetween; and a nut member that is through-coupled to the nut member coupling part and is disposed to face the tank cover with the washer member interposed therebetween.

In this case, the water tank may be provided, wherein the nut member is provided as a hard lock nut.

In addition, the water tank may be provided, wherein the fastening part includes a snap ring member that is coupled to the snap ring member coupling part, and is configured to prevent loosening of a nut member that is coupled to the nut member coupling part.

In this case, the water tank may be provided, wherein the diameter of a cross-section of the snap ring member coupling part is formed to be less than the diameter of a cross-section of the nut member coupling part and the diameter of a cross-section of the reinforcing head.

According to the above configuration, the water tank according to an embodiment of the present disclosure can prevent deformation due to the pressure of a fluid contained inside.

In addition, according to the above configuration, the water tank according to an embodiment of the present disclosure can maintain a constant amount of fluid provided to the outside.

In addition, according to the above configuration, the water tank according to an embodiment of the present disclosure can maintain a constant temperature of the fluid provided to the outside.

In addition, according to the above configuration, the water tank according to an embodiment of the present disclosure can prevent deformation without excessive structural changes.

In addition, according to the above configuration, the water tank according to an embodiment of the present disclosure can achieve the above objects without excessive increase in volume.

In addition, according to the above configuration, interference with other elements positioned in the installation space can be minimized.

The effects of the present disclosure are not limited to the above-described effects, and should be understood to include all effects that can be inferred from the configurations of the invention described in the detailed description or claims of the present disclosure.

### BRIEF DESCRIPTION OF THE DRAWINGS

FIG. 1 is a perspective view illustrating a water tank according to an embodiment of the present disclosure.

FIG. 2 is an exploded perspective view illustrating the configuration of the water tank of FIG. 1.

FIG. 3 is a perspective view illustrating the configuration of the water tank of FIG. 1.

FIG. 4 is a perspective view illustrating the configuration of the water tank of FIG. 1 from another angle.

FIG. 5 is a front view illustrating the water tank of FIG. 3.

FIG. 6 is an exploded perspective view illustrating the configuration of the water tank of FIG. 3.

FIG. 7 is a perspective view illustrating a tank cover provided in the water tank of FIG. 1.

FIG. 8 is a front view illustrating the tank cover of FIG. 7.

FIG. 9 is an A-A cross-sectional view illustrating the tank cover of FIG. 7.

FIG. 10 is a perspective view illustrating a tank body and a reinforcing member provided in the water tank of FIG. 1.

FIG. 11 is an exploded perspective view illustrating the configuration of the tank body and reinforcing member of FIG. 10.

FIG. 12 is a front view illustrating the tank body of FIG. 10.

FIG. 13 is a back view illustrating the tank body of FIG. 10.

FIG. 14 is a B-B cross-sectional view illustrating the tank body of FIG. 10.

FIG. 15 is a perspective view illustrating a reinforcing member provided in the water tank of FIG. 1.

FIG. 16 is a side view illustrating the reinforcing member of FIG. 15.

FIG. 17 is an exploded perspective view illustrating a fastening part provided in the water tank of FIG. 1.

FIG. 18 is a perspective view illustrating the coupling relationship of each component of the water tank of FIG. 1.

FIG. 19 is a C-C cross-sectional view illustrating the coupling relationship of each component of the water tank of FIG. 18.

FIG. 20 is an enlarged cross-sectional view of part A of FIG. 19.

### DETAILED DESCRIPTION OF THE EMBODIMENTS

Hereinafter, with reference to the attached drawings, embodiments of the present disclosure will be described in detail so that one of ordinary skill in the art to which the present disclosure pertains can easily practice the present disclosure. The present disclosure may be implemented in various different forms and is not limited to the embodiments described herein. In order to clearly describe the present disclosure, parts that are not related to the description in the drawings have been omitted, and the same reference numerals have been assigned to identical or similar components throughout the specification.

The words and terms used in the present specification and claims should not be interpreted as limited to their conventional or dictionary meanings, but should be interpreted as meanings and concepts that conform to the technical idea of the present disclosure according to the principle that the inventor can define terms and concepts in order to explain his or her invention in the best way.

Therefore, the embodiments described in the present specification and the configurations depicted in the drawings correspond to preferred embodiments of the present disclosure and do not represent all of the technical ideas of the present disclosure, and thus, the corresponding configurations may have various equivalents and modified examples that can replace the same at the time of filing of the present disclosure.

In the following description, the description of some components may be omitted in order to clarify the features of the present disclosure.

The term “fluid connection” used in the following description means that one or more members are connected to each other in a fluidic manner. In one embodiment, the fluid connection may be formed by members such as conduits, pipes and piping. In the following description, the fluid connection may be used in the same sense as “fluidically connecting” one or more members to each other.

The term “electrical conduction” used in the following description means that one or more members are connected to each other in a way that allows electric current or an electrical signal to be transmitted. In one embodiment, the electrical conduction may be formed in a wired form such as a conductor member or in a wireless form such as Bluetooth, Wi-Fi or RFID. In one embodiment, the electrical conduction may include the meaning of “communication.”

The term “fluid” used in the following description means any form of material that flows by an external force and can be transformed in shape or volume. In one embodiment, the fluid may be a liquid such as water or a gas such as air.

The terms “upper”, “lower”, “left”, “right”, “front” and “back” used in the following description shall be understood with reference to the coordinate system illustrated throughout the accompanying drawings.

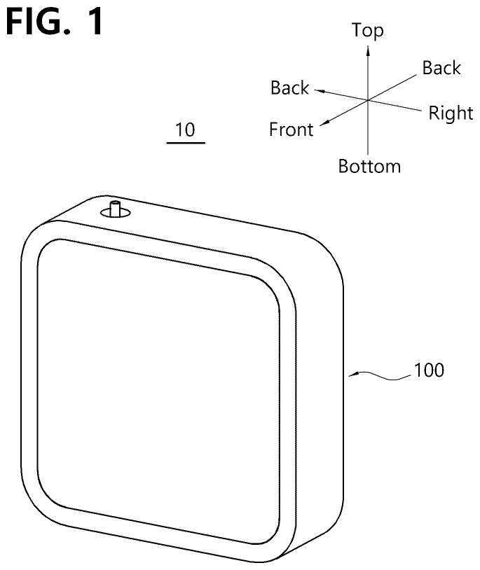

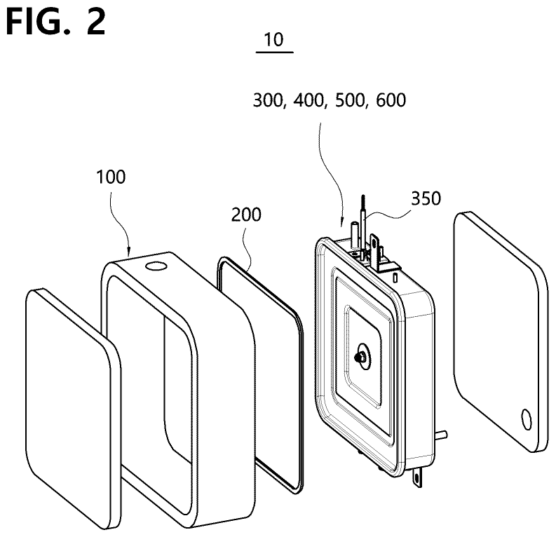

Referring to FIGS. 1 and 2, a water tank 10 according to an embodiment of the present disclosure is illustrated. The water tank 10 according to an embodiment of the present disclosure is fluidically connected to the outside and may receive and store any fluid. For example, the water tank 10 may receive and store purified water produced by filtering raw water or cold or hot water produced by cooling or heating purified water.

The water tank 10 may be formed of a high-strength material. In addition, the water tank 10 may be formed of a material that does not rust due to a reaction with a fluid. In one embodiment, the water tank 10 may be formed of a stainless-steel material.

A space may be formed inside the water tank 10. The space may accommodate a fluid provided from the outside. In this case, the water tank 10 may be configured such that the space is sealed except for a passage for receiving a fluid from the outside or providing a fluid to the outside.

Therefore, when a fluid flows into or out of the space of the water tank 10, the pressure of the space may change. This pressure change may affect the outer shape of the water tank 10 surrounding the space. For example, the outer shape of the water tank 10 may expand or contract due to a pressure change.

If the above process is repeated, the water tank 10 may be subject to stress fatigue. In addition, even if the water tank 10 is not destroyed, the volume of the space may be deformed, and the amount of a fluid provided to the outside from the water tank 10 may vary. Furthermore, as the amount of a fluid provided to the outside after being heated or cooled in the water tank 10 changes, the temperature of the fluid provided to the user may also be arbitrarily changed.

In order to prevent this, the water tank 10 according to an embodiment of the present disclosure is configured to improve the pressure resistance of its own structure by changing the external structure. Furthermore, the water tank 10 according to an embodiment of the present disclosure is configured to include additional configurations (i.e., the tank cover reinforcing part 200 and the tank body reinforcing part 400 to be described below) for reinforcing the rigidity according to the external structure change. A detailed description thereof will be described below.

The water tank 10 according to an embodiment of the present disclosure may be provided in any device requiring the storage and provision of a fluid. In one embodiment, the water tank 10 may be provided and utilized in a water purifier. In another embodiment, the water tank 10 may be provided and utilized in a water softener or the like.

Meanwhile, the water tank 10 may be formed in a polygonal prism shape. In the illustrated embodiment, the water tank 10 has a three-dimensional shape with a square cross-section and a height in the vertical direction. As the water tank 10 is formed in the shape as described above, the volume of the space occupied by the water tank 10 may be minimized. As a result, interference with other components of the device in which the water tank 10 is provided may be minimized, and the degree of freedom in the arrangement of the water tank 10 may be improved.

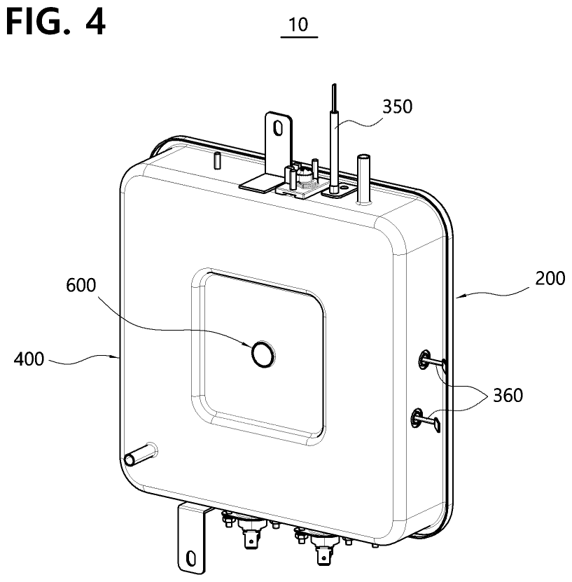

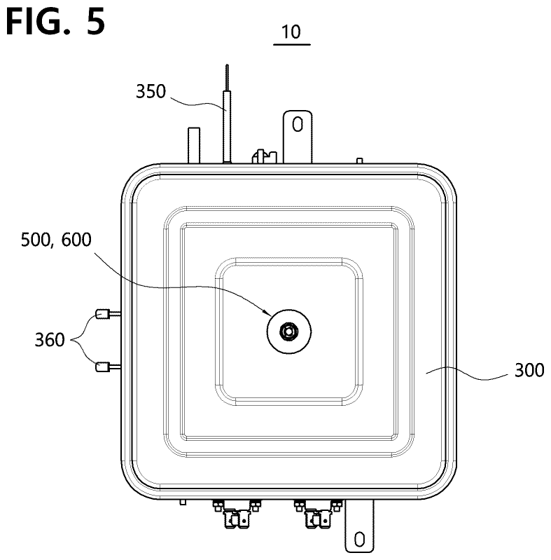

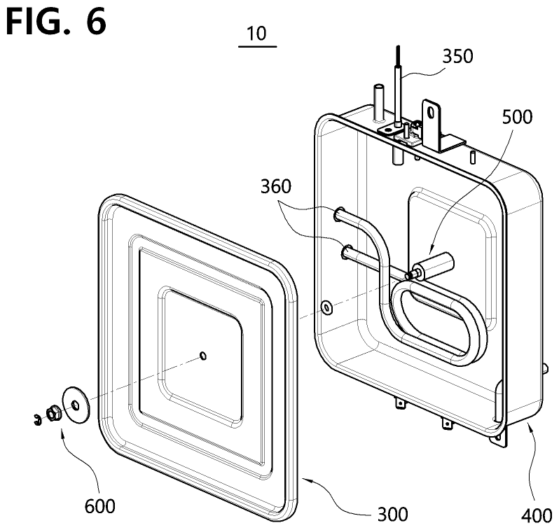

In the embodiments illustrated in FIGS. 1 to 6, the water tank 10 includes a heat insulating member 100, a sealing member 200, a tank cover 300, a tank body 400, a reinforcing member 500 and a fastening part 600.

The heat insulating member 100 constitutes a part of the outer shape of the water tank 10. The heat insulating member 100 surrounds other components of the water tank 10, thereby preventing temperature changes of the water or hot or cold water generated by heating or cooling the water flowing into the water tank 10.

To this end, the heat insulating member 100 may be formed of a material having low thermal conductivity. In one embodiment, the heat insulating member 100 may be formed of a material such as expanded Styrofoam.

The heat insulating member 100 is coupled to the sealing member 200. The space between the heat insulating member 100 and the tank cover 300 may be sealed by the sealing member 200.

The heat insulating member 100 is coupled to the tank cover 300 and the tank body 400, respectively. The heat insulating member 100 is formed to surround the tank cover 300 and the tank body 400 from the outside, thereby thermally sealing a fluid contained in a tank body space 420 formed inside the tank cover 300 and the tank body 400.

The heat insulating member 100 is coupled to the reinforcing member 500 and the fastening part 600, respectively. Specifically, the heat insulating member 100 surrounds the reinforcing member 500 and the fastening part 600 coupled to the tank cover 300 and the tank body 400 from the outside, and is coupled thereto.

The heat insulating member 100 may be provided in any form that can surround the other configurations of the water tank 10 from the outside and thermally block the same from the outside.

In the illustrated embodiment, the heat insulating member 100 is configured to include a part formed in a plate shape that surrounds the other configurations of the water tank 10 from the front side and the back side. In addition, the heat insulating member 100 is configured to include another part that extends to surround the other configurations of the water tank 10 from the left, right, upper and lower sides.

The sealing member 200 is positioned between the heat insulating member 100 and the tank cover 300 and seals a space therebetween. The heat insulating member 100 and the tank cover 300 are tightly coupled by the sealing member 200 such that heat exchange with the outside may be blocked.

The sealing member 200 is coupled to the heat insulating member 100. The sealing member 200 is surrounded by the heat insulating member 100 and is not exposed to the outside. In the illustrated embodiment, the sealing member 200 is surrounded by the heat insulating member 100 on the front side, upper side, lower side, left side and right side.

The sealing member 200 is coupled to the tank cover 300. The sealing member 200 may be tightly coupled to the tank cover 300. In the illustrated embodiment, the back side of the sealing member 200 is coupled to the tank cover 300.

The sealing member 200 may have any shape that can be coupled to the heat insulating member 100 and the tank cover 300, respectively, to seal a space therebetween. In the illustrated embodiment, the sealing member 200 is formed in a rectangular ring shape that extends along the outer periphery of the heat insulating member 100 or the tank cover 300 and has a hollow space formed inside.

The sealing member 200 may be formed of a material having a predetermined elasticity. When it is coupled to the heat insulating member 100 and the tank cover 300, it is compressed and deformed in shape so as to be tightly coupled to the heat insulating member 100 and the tank cover 300, respectively. In one embodiment, the sealing member 200 may be formed of a material such as rubber or silicone.

The tank cover 300 constitutes a part of a configuration that receives a fluid delivered to the water tank 10. The tank cover 300 is configured to seal the tank body space 420 in which the fluid is received.

The tank cover 300 may be formed of a material that has high strength but does not rust. In one embodiment, the tank cover 300 may be formed of a stainless-steel material.

The tank cover 300 is coupled to the heat insulating member 100. The tank cover 300 is surrounded by the heat insulating member 100 and is not arbitrarily exposed to the outside. Accordingly, arbitrary temperature changes of the fluid contained in the tank body space 420 partially covered by the tank cover 300 may be prevented. The tank cover 300 is surrounded by the heat insulating member 100 on one side in the thickness direction, that is, the front side, and on each side in the height direction and width direction, that is, the left side, the right side, the upper side and the lower side.

The tank cover 300 is coupled to the sealing member 200. The tank cover 300 may be tightly coupled to the heat insulating member 100 through the sealing member 200. In the illustrated embodiment, the tank cover 300 is coupled to the sealing member 200 on one side in the thickness direction, that is, the front side.

The tank cover 300 is coupled to the tank body 400. The tank cover 300 covers the tank body space 420 formed inside the tank body 400 and may be coupled to the tank body 400. In the illustrated embodiment, the tank cover 300 is coupled to the tank body 400 on the other side in the thickness direction, that is, the back side. The tank cover 300 may seal the tank body space 420.

The tank cover 300 is coupled to the reinforcing member 500. The rigidity of the tank cover 300 or the bonding force with the tank body 400 may be reinforced by the reinforcing member 500. Accordingly, even if the pressure of the tank body space 420 changes according to the inflow and outflow of a fluid, damage to the tank cover 300 may be prevented. A detailed description thereof will be provided below.

The tank cover 300 is coupled to the fastening part 600. The tank cover 300 may be coupled to the reinforcing member 500 by the fastening part 600. The fastening part 600 is positioned on the one side, that is, the front side, in the thickness direction of the tank cover 300 and is coupled to the reinforcing member 500 exposed on the one side to support the same.

The tank cover 300 is coupled to the tank body 400 to seal the tank body space 420, and may have any shape that can reinforce the rigidity or bonding force with the tank body 400 by being coupled to the reinforcing member 500 and the fastening part 600. In the illustrated embodiment, the tank cover 300 is formed in a polygonal plate shape having a thickness in the front-back direction, a width in the left-right direction, and a height in the up-down direction.

The shape of the tank cover 300 may be changed to correspond to the shape of the tank body 400.

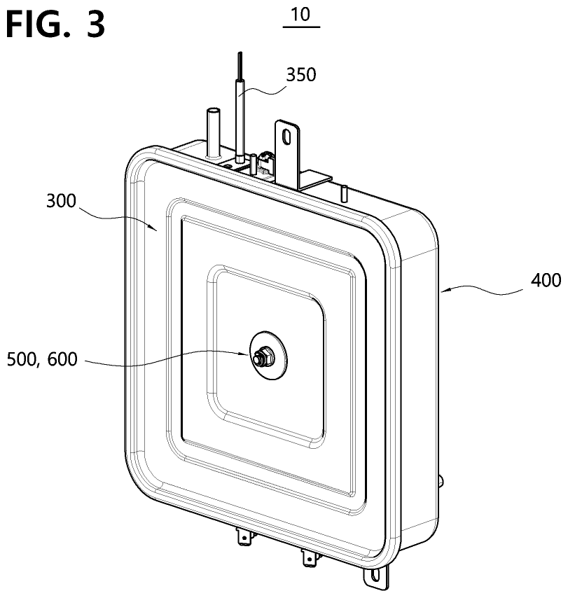

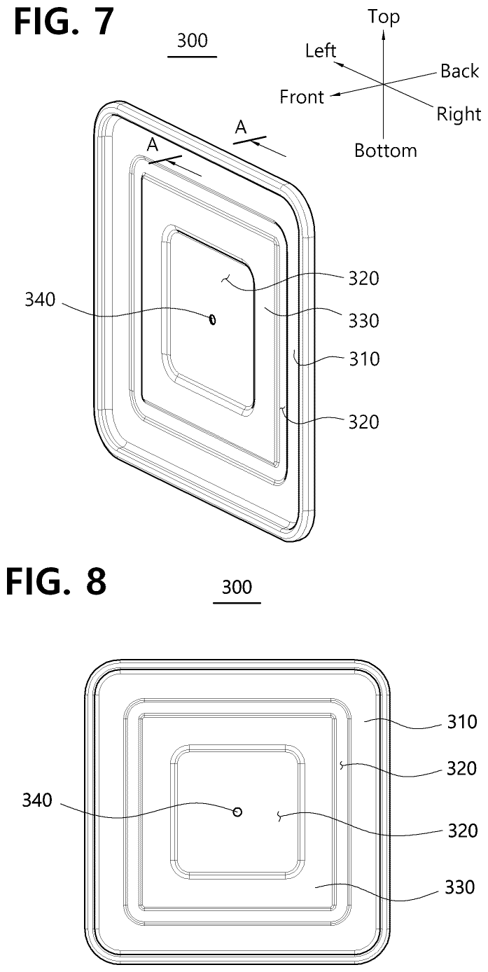

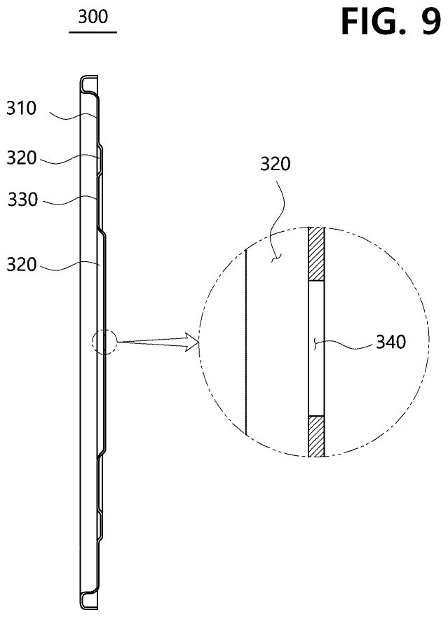

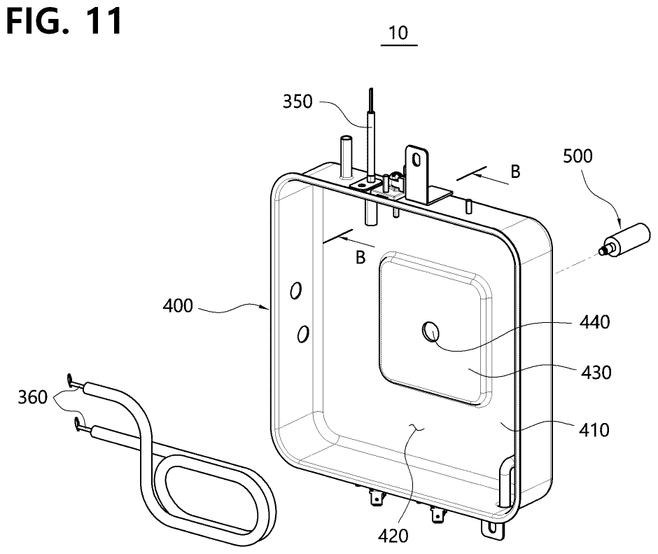

In the illustrated embodiments in FIGS. 3 to 11, the tank cover 300 includes a tank cover surface 310, a tank cover recessed part 320, a tank cover boss part 330, a tank cover penetration hole 340, a sensor member 350 and a cooling member 360.

The tank cover surface 310 constitutes the body of the tank cover 300. The tank cover surface 310 is a part where the tank cover 300 is coupled to the tank body 400. In addition, the tank cover surface 310 covers a tank body space 420 formed inside the tank body 400.

The tank cover surface 310 may be formed in a shape corresponding to the shape of the tank body 400 or the tank body space 420 formed inside the tank body 400. In the illustrated embodiment, the tank cover surface 310 is formed in a polygonal plate shape having a width in the left-right direction, a height in the up-down direction, and a thickness in the front-back direction.

In the above embodiment, each corner of the tank cover surface 310 in the width direction and the height direction may be coupled to the tank body 400. In addition, each corner of the tank cover surface 310 may be coupled to the sealing member 200.

The tank cover recessed part 320 is formed on a part of the inside of the tank cover surface 310. In the illustrated embodiment, the tank cover recessed part 320 is formed on the inside of each corner of the tank cover surface 310.

The tank cover boss part 330 is formed on another part of the inside of the tank cover surface 310. In the illustrated embodiment, the tank cover boss part 330 is formed on the inner side of each corner of the tank cover surface 310 on the one part where the tank cover recessed part 320 is formed. The tank cover boss part 330 divides the tank cover recessed part 320 into a plurality of spaces along the radial direction.

The tank cover penetration hole 340 is formed through the tank cover surface 310. In the illustrated embodiment, the tank cover penetration hole 340 is formed through a center part of the tank cover surface 310 where the tank cover recessed part 320 is formed.

Each corner in the width direction and height direction of the tank cover surface 310 may be formed by bending. Each of the above corners of the tank cover surface 310 may be coupled to each corner of the tank body 400.

The tank cover surface 310 may be supported by the reinforcing member 500 and the fastening part 600. As will be described below, the reinforcing member 500 may be coupled to a tank body surface 410 of the tank body 400 and may be coupled to the tank cover surface 310 to support the same. The fastening part 600 may be configured to maintain the coupling of the tank cover surface 310 and the reinforcing member 500.

Therefore, even if a fluid flows into or out of the tank body space 420 and a pressure change occurs, the tank cover surface 310 may be supported by the reinforcing member 500 and the tank body 400 coupled thereto, thereby preventing shape deformation or damage.

The tank cover recessed part 320 is a space formed inside the tank cover surface 310. The tank cover recessed part 320 is formed on one side of the thickness direction of the tank cover surface 310, which is the front side surface in the illustrated embodiment. The part of the tank cover surface 310 where the tank cover recessed part 320 is formed may be positioned closer to the tank body 400 than the part where the tank cover recessed part 320 is not formed.

The tank cover recessed part 320 is positioned to be spaced apart from the corner of the tank cover surface 310. In the illustrated embodiment, the tank cover recessed part 320 is positioned inward compared to each corner of the tank cover surface 310 in the width direction and height direction, that is, the upper, lower, left and right corners.

The tank cover recessed part 320 may have a shape corresponding to the shape of the tank cover surface 310. In the illustrated embodiment, the tank cover recessed part 320 has a rectangular cross-section and is formed as a polygonal space having a thickness in the front-back direction.

The tank cover boss part 330 is positioned inside the tank cover recessed part 320. In addition, the tank cover penetration hole 340 is positioned inside the tank cover recessed part 320. A part of the reinforcing member 500 and the fastening part 600 coupled to the part of the reinforcing member 500 may be positioned in the tank cover recessed part 320.

The tank cover recessed part 320 may be divided into a plurality of parts by the tank cover boss part 330.

That is, in the illustrated embodiment, the tank cover recessed part 320 may be divided into a part positioned between the radially outer side of the tank cover boss part 330 and each corner of the tank cover surface 310 and another part positioned radially inner side of the tank cover boss part 330 and in which the tank cover penetration hole 340 is formed.

The part may form a convex-concave shape together with the other part of the tank cover surface 310 and the tank cover boss part 330. That is, the tank cover recessed part 320 may play a role in reinforcing the rigidity of the tank cover 300 by changing the shape of the tank cover 300 together with the other part of the tank cover surface 310 and the tank cover boss part 330.

In addition, the other part may accommodate the part of the reinforcing member 500 and the fastening part 600. The other part may be defined by being surrounded by the tank cover boss part 330. Therefore, even if the part of the reinforcing member 500 and the fastening part 600 are accommodated in the other part, the length protruding to the outside may be minimized such that interference with other configurations can be prevented.

The tank cover boss part 330 is a raised part inside the tank cover surface 310. The tank cover boss part 330 is formed by being raised on the one side in the thickness direction of the tank cover surface 310, that is, on the front side surface in the illustrated embodiment. Among the parts of the tank cover surface 310, the part where the tank cover boss part 330 is formed may be positioned further from the tank body 400 than the part where the tank cover boss part 330 is not formed.

The tank cover boss part 330 is positioned on the inside of the tank cover surface 310 so as to be spaced apart from the corner of the tank cover surface 310. The tank cover boss part 330 is positioned in the tank cover recessed part 320 and may divide the tank cover recessed part 320 into a plurality of spaces.

In the illustrated embodiment, the tank cover boss part 330 is positioned on the inner side with respect to the outer corner of the tank cover recessed part 320 and is positioned between each part of the tank cover recessed part 320 divided into a plurality of parts along the radial direction. The tank cover boss part 330 is positioned between one part of the tank cover recessed part 320 that is positioned on the radially outer side and another part that is positioned on the radially inner side among a plurality of parts of the tank cover recessed part 320.

The tank cover boss part 330 surrounds the one part of the tank cover recessed part 320 and surrounds the other part of the tank cover recessed part 320.

The tank cover boss part 330 may have a shape corresponding to the shape of the tank cover surface 310 or the tank cover recessed part 320. In the illustrated embodiment, the tank cover boss part 330 has a rectangular cross-section and a thickness in the front-back direction, and the other part of the tank cover recessed part 320 is positioned inside the same.

As described above, the tank cover boss part 330 may form a roughness together with the tank cover surface 310 and the tank cover recessed part 320. The tank cover boss part 330 may play a role in reinforcing the rigidity of the tank cover 300 by changing the shape of the tank cover 300 together with the tank cover recessed part 320.

The tank cover penetration hole 340 is a part where the tank cover 300 is coupled to the reinforcing member 500. The tank cover penetration hole 340 is positioned inside the tank cover surface 310. The tank cover penetration hole 340 is formed to penetrate in the thickness direction of the tank cover surface 310, which is in the front-back direction in the illustrated embodiment.

The tank cover penetration hole 340 may be positioned at a part where the tank cover recessed part 320 is formed. In the illustrated embodiment, the tank cover penetration hole 340 is positioned adjacent to the center of the tank cover surface 310, and is positioned at another part of the tank cover recessed part 320. The tank cover boss part 330 is positioned in the radial direction of the tank cover penetration hole 340. The radially outer side of the tank cover penetration hole 340 may be surrounded by the tank cover boss part 330.

An O-ring member coupling part 520 of a reinforcing member 500 is through-coupled to the tank cover penetration hole 340. For this purpose, the tank cover penetration hole 340 may have a shape corresponding to the shape of the O-ring member coupling part 520. In the illustrated embodiment, the tank cover penetration hole 340 is formed as a space in the shape of a disc having a circular cross-section and a thickness in the front-back direction.

In the above embodiment, the diameter of the cross-section of the tank cover penetration hole 340 may be formed to be less than or equal to the diameter of the cross-section of the O-ring member coupling part 520. Therefore, the tank cover penetration hole 340 is sealed by the O-ring member coupling part 520 such that the fluid contained in the tank body space 420 may not be randomly leaked.

The sensor member 350 generates arbitrary detection information on the state of a fluid contained inside the tank body 400. The sensor member 350 is electrically connected to a control unit (not illustrated) such that the generated detection information may be transmitted to the control unit (not illustrated).

The sensor member 350 may generate arbitrary detection information related to the state of a fluid contained inside the tank body 400. In one embodiment, the sensor member 350 may generate detection information related to the temperature, flow rate, water level, turbidity and the like of the fluid contained inside the tank body 400.

The sensor member 350 is coupled to the tank body 400. Specifically, the sensor member 350 is through-coupled to one surface of the tank body 400 surrounding the tank body space 420 in a radial direction, which is the upper side surface in the illustrated embodiment.

The sensor member 350 is at least partially exposed to the tank body space 420 and may generate sensing information on the state of a fluid. The sensor member 350 is at least partially exposed to the outside of the tank body space 420 and may be electrically connected to a control unit (not illustrated).

The cooling member 360 is configured to cool the fluid contained inside the tank body 400. The cooling member 360 is electrically connected to the control unit (not illustrated) and the operation thereof may be controlled by the control unit (not illustrated). In one embodiment, the cooling member 360 may be operated in accordance with the sensing information generated by the sensor member 350.

The cooling member 360 is coupled to the tank body 400. Specifically, the cooling member 360 is through-coupled to the other surface of the tank body 400 surrounding the tank body space 420 in a radial direction, which is the right-side surface in the illustrated embodiment.

A part of the cooling member 360 is positioned in the tank body space 420 and may cool a fluid flowing in the tank body space 420. Another part of the cooling member 360 is positioned outside the tank body space 420 and may be electrically connected to a control unit (not illustrated).

The illustrated embodiment assumes that the cooling member 360 cools the fluid contained in the tank body space 420. Alternatively, it will be understood that the cooling member 360 may be provided in the form of a heating member to heat the fluid contained in the tank body space 420.

The above-described sensor member 350 and cooling member 360 are coupled to the tank body 400. Therefore, it will be understood that the sensor member 350 and cooling member 360 may be defined as components of the tank body 400.

The tank body 400 constitutes another part of the configuration that receives the fluid delivered to the water tank 10. A tank body space 420 in which the fluid is received is formed inside the tank body 400.

The tank body 400 may be formed of a material that is highly rigid but does not rust. In one embodiment, the tank body 400 may be formed of a stainless-steel material.

The tank body 400 is coupled to the tank cover 300. The tank body space 420 formed inside the tank body 400 may be covered and closed by the tank cover 300.

The tank body 400 is coupled to a reinforcing member 500. The tank body 400 may be coupled to one side of the reinforcing member 500 to support the same. In one embodiment, the tank body 400 may be fixedly coupled to the reinforcing member 500. In the above embodiment, the tank body 400 may be welded and coupled to the reinforcing member 500.

By the above coupling, the tank body 400 may support the tank cover 300 coupled to the reinforcing member 500. Accordingly, the tank cover 300 may be prevented from being deformed or damaged despite pressure changes due to fluid inflow and outflow. A detailed description thereof will be provided below.

The tank body 400 may be any shape that is coupled to the tank cover 300 to form a space that is capable of containing a fluid, and may be coupled to a reinforcing member 500 to support the tank cover 300. In the illustrated embodiment, the tank body 400 is formed in a polygonal plate shape having a width in the left-right direction, a height in the up-down direction, and a thickness in the front-back direction.

Accordingly, the combination of the tank body 400 and the tank cover 300 may also be formed in a polygonal plate shape having a width in the left-right direction, a height in the up-down direction, and a thickness in the front-back direction. Accordingly, the space occupied by the combination of the tank body 400 and the tank cover 300 may be minimized such that interference with other components can be minimized.

The shape of the tank body 400 may be changed to correspond to the shape of the tank cover 300.

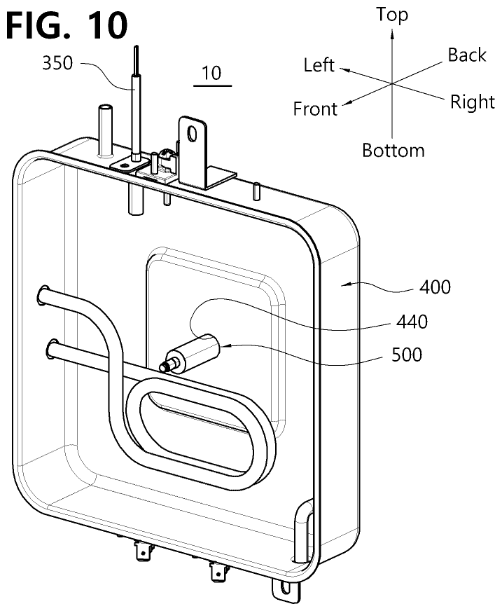

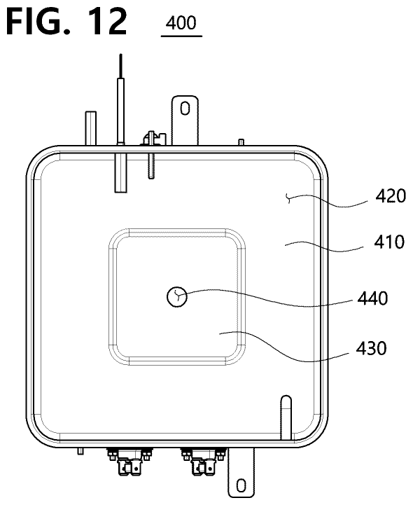

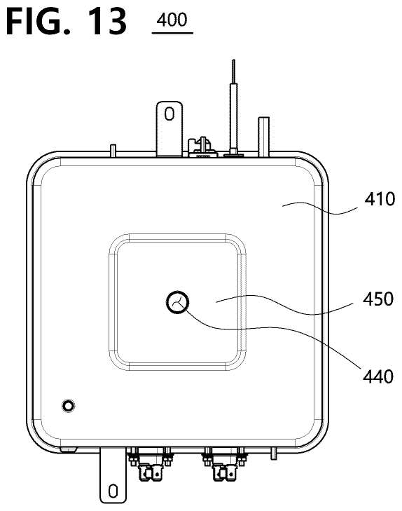

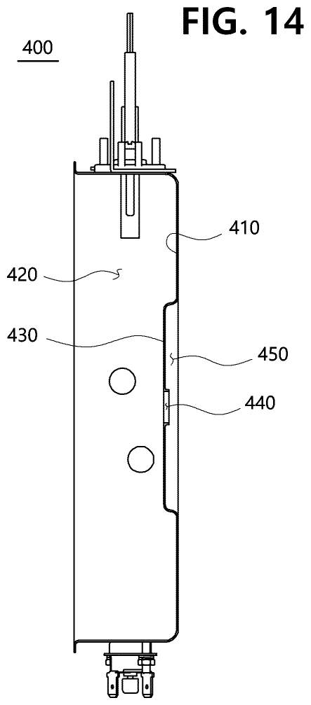

In the embodiments illustrated in FIGS. 10 to 14, the tank body 400 includes a tank body surface 410, a tank body space 420, a tank body boss part 430, a tank body through-hole 44, and a tank body recessed part 450.

The tank body surface 410 constitutes a part of the outer shape of the tank body 400. The tank body surface 410 covers the tank body space 420 on one side in the thickness direction, which is the back side in the illustrated embodiment. The tank body surface 410 is arranged to face the tank cover surface 310 with the tank body space 420 interposed therebetween.

The tank body surface 410 may have a shape corresponding to the shape of the tank body space 420. In the illustrated embodiment, the tank body surface 410 is formed as a polygonal plate having a width in the left-right direction, a height in the up-down direction, and a thickness in the front-back direction.

The tank body surface 410 is continuous with other surfaces (not assigned a drawing symbol) of the tank body 400 that surround the tank body space 420 in the radial direction. Each corner of the tank body surface 410 is continuous with the other surfaces at a predetermined angle.

A tank body boss part 430 is formed inside the tank body surface 410. In the illustrated embodiment, the tank body boss part 430 is formed as a raised part on one side of the thickness direction of the tank body surface 410, that is, the front side, on the inside of each corner of the tank body surface 410.

A tank body penetration hole 440 is formed inside the tank body surface 410. In the illustrated embodiment, the tank body penetration hole 440 is positioned inside the tank body boss part 430, adjacent to the center of the tank body surface 410.

A tank body recessed part 450 is formed inside the tank body surface 410. The tank body recessed part 450 may be formed at a position corresponding to the position of the tank body boss part 430. In the illustrated embodiment, the tank body recessed part 450 is recessed and formed on the inner side of each corner of the tank body surface 410, which is the other side in the thickness direction of the tank body surface 410, that is, the back side.

The tank body surface 410 is coupled to the reinforcing member 500. The tank body surface 410 is coupled to the reinforcing body 510 to support the same. In the illustrated embodiment, the tank body face 410 is coupled to a reinforcing body 510 that is penetrated by a tank body penetration hole 440.

Alternatively, the tank body face 410 may not have a tank body penetration hole 440 formed therein, and one longitudinal end of the reinforcing body 510, which is a back end in the illustrated embodiment, may be directly coupled to the tank body face 410.

The tank body space 420 is a space formed inside the tank body 400. The tank body space 420 is fluidly connected to the outside and may receive and store a fluid. In addition, the tank body space 420 may provide the stored fluid to the outside according to the user's request.

The tank body space 420 is defined by being surrounded by other configurations of the tank body 400. In the illustrated embodiment, the tank body space 420 is defined by being surrounded by the tank body surface 410 and other surfaces (not assigned a drawing symbol) of the tank body 400 that are continuous with the tank body surface 410.

The tank body space 420 may be covered by the tank cover 300. That is, the tank body space 420 may be closed on one side in the thickness direction, which is the front side in the illustrated embodiment, by the tank cover surface 310.

The tank body space 420 may have a shape corresponding to the shape of the tank cover surface 310 or the tank body surface 410. In the illustrated embodiment, the tank body space 420 is formed as a polygonal prism-shaped space having a rectangular cross-section and a height in the front-back direction.

A part of the sensor member 350 and a part of the cooling member 360 are positioned in the tank body space 420. The part of the sensor member 350 and the part of the cooling member 360 may be in contact with the fluid contained in the tank body space 420.

A tank body boss part 430 is positioned in the tank body space 420. The tank body boss part 430 is formed to protrude from the tank body surface 410 toward the tank body space 420.

A part of a reinforcing member 500 is positioned in the tank body space 420. Specifically, a reinforcing body 510 is positioned in the tank body space 420. The reinforcing body 510 may extend between the tank cover surface 310 and the tank body surface 410.

The tank body boss part 430 is positioned in the tank body surface 410. The tank body boss part 430 is formed by protruding toward the tank body space 420 on one side of each side of the tank body surface 410, which is the front side in the illustrated embodiment.

The tank body boss part 430 is positioned inside the tank body surface 410. The tank body boss part 430 is positioned on the inside of each corner of the tank body surface 410.

A tank body penetration hole 440 is formed through the tank body boss part 430. The tank body boss part 430 may support one end of the reinforcing body 510 of the reinforcing member 500 that is through-coupled to the tank body penetration hole 440.

The tank body boss part 430 may have a shape corresponding to the shape of the tank body surface 410. In the illustrated embodiment, the tank body boss part 430 has a rectangular cross-section and is formed as a polygonal plate having a thickness in the front-back direction.

The tank body boss part 430 may reinforce the rigidity of the tank body surface 410 by changing the structure of the tank body surface 410. That is, the tank body boss part 430 may form a roughness together with a part of the tank body surface 410 where the tank body boss part 430 is not formed.

Accordingly, the pressure distribution applied to the tank body surface 410 is alleviated such that the rigidity of the tank body surface 410 against pressure changes occurring in the tank body space 420 may be reinforced.

The tank body penetration hole 440 is formed through the tank body boss part 430. The tank body penetration hole 440 is a part where the reinforcing body 510 of the reinforcing member 500 is penetrated and coupled. The tank body penetration hole 440 is positioned inside the tank body surface 410. In the illustrated embodiment, the tank body penetration hole 440 is positioned adjacent to the center of the tank body surface 410.

The position of the tank body penetration hole 440 may be changed to correspond to the position of the tank cover penetration hole 340. That is, the tank body penetration hole 440 and the tank cover penetration hole 340 may be positioned on the same central axis.

The tank body penetration hole 440 may have a shape corresponding to the shape of the reinforcing body 510. In the illustrated embodiment, the tank body penetration hole 440 is formed as a space having a circular cross-section and a thickness in the front-back direction. In the above embodiment, the diameter of the cross-section of the tank body penetration hole 440 may be formed to be less than or equal to the diameter of the cross-section of the reinforcing body 510.

Accordingly, the tank body penetration hole 440 is closed by the reinforcing body 510 through-coupled thereto such that any leakage of the fluid contained in the tank body space 420 may be prevented.

The tank body recessed part 450 is positioned inside the tank body surface 410. The tank body recessed part 450 is formed to be recessed on the other side of the tank body surface 410 opposite to the tank body space 420, which is on the back side in the illustrated embodiment.

The tank body recessed part 450 may be formed at a position corresponding to the position of the tank body boss part 430. In the illustrated embodiment, the tank body recessed part 450 is positioned on the inner side of each corner of the tank body surface 410, adjacent to the center of the tank body surface 410. The tank body recessed part 450 is arranged to overlap the tank body boss part 430 along the thickness direction of the tank body surface 410, which is the front-back direction in the illustrated embodiment.

The tank body recessed part 450 may have a shape corresponding to the shape of the tank body boss part 430. In the illustrated embodiment, the tank body recessed part 450 is formed as a polygonal plate-shaped space having a rectangular cross-section and a thickness in the front-back direction.

The tank body recessed part 450 surrounds the tank body penetration hole 440 from the outside. The tank body penetration hole 440 may be easily identified by the tank body recessed part 450. Accordingly, the process of coupling the reinforcing member 500 and the tank body penetration hole 440 may be easily performed.

The tank body recessed part 450 may change the structure of the tank body surface 410 to reinforce the rigidity of the tank body surface 410. That is, the tank body recessed part 450 may form a roughness together with a part of the tank body surface 410 where the tank body recessed part 450 is not formed.

Accordingly, the pressure distribution applied to the tank body surface 410 is alleviated such that the rigidity of the tank body surface 410 against pressure changes occurring in the tank body space 420 may be reinforced.

The reinforcing member 500 substantially performs the role of reinforcing the rigidity of the tank cover 300 and the tank body 400. By the reinforcing member 500, the tank cover 300 and the tank body 400 may be supported against each other. Accordingly, the rigidity of the tank cover 300 and the tank body 400 is reinforced such that shape change or damage due to pressure change of the fluid may be prevented.

The reinforcing member 500 is coupled to the tank cover 300. Some components of the reinforcing member 500 penetrate the tank cover 300. The above-mentioned some components penetrate the tank cover 300 and are exposed to the outside of the tank body space 420. Other components of the reinforcing member 500 are positioned in the tank body space 420 and support the tank cover 300.

The reinforcing member 500 is coupled to the tank body 400. Another configuration of the reinforcing member 500 penetrates the tank body 400. The other configuration is positioned in the tank body space 420 and is coupled to the tank body surface 410.

Accordingly, the reinforcing member 500 may be coupled to the tank cover 300 and the tank body 400 to support the same, respectively.

The reinforcing member 500 is coupled to the fastening part 600. The above-mentioned some components of the reinforcing member 500, that is, the part positioned outside the tank body space 420, may be coupled to the tank cover 300 by the fastening part 600. Accordingly, the reinforcing member 500 may support the tank cover 300 on each side in the thickness direction, which is the front side and the back side in the illustrated embodiment, respectively.

As a result, the reinforcing member 500 may support the tank cover 300 on each side in the thickness direction, which is the front side and the back side, and may support the tank body 400 on one side in the thickness direction, which is the front side.

The reinforcing member 500 may be formed of a material that is lightweight and has high strength. In addition, the reinforcing member 500 may be formed of a material that does not rust when in contact with a fluid. The reinforcing member 500 is at least partially positioned in the tank body space 420, so as to prevent contamination of the fluid contained in the tank body space 420. In one embodiment, the reinforcing member 500 can be formed of a stainless-steel material.

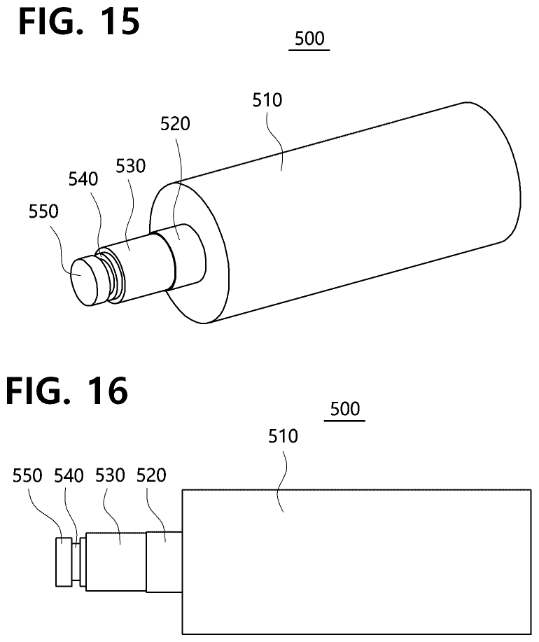

In the embodiments illustrated in FIGS. 15 and 16, the reinforcing member 500 includes a reinforcing body 510, an O-ring member coupling part 520, a nut member coupling part 530, a snap ring member coupling part 540 and a reinforcing head 550.

The reinforcing body 510 constitutes a part of the outer shape of the reinforcing member 500. The reinforcing body 510 is a part where the reinforcing member 500 is coupled to the tank body 400.

Specifically, the reinforcing body 510 penetrates the tank body penetration hole 440 and is coupled to one side of the tank body surface 410, which is the front side in the illustrated embodiment. In the above embodiment, the reinforcing body 510 may be welded to an inner circumference surrounding the tank body penetration hole 440 among a part of the tank body surface 410.

As described above, in the non-illustrated embodiment, the tank body penetration hole 440 is not formed and the reinforcing body 510 may be directly connected to the tank body surface 410. In the above embodiment, the end of the reinforcing body 510 may be welded to the end of the tank body surface 410.

The reinforcing body 510 may have a shape corresponding to the shape of the tank body penetration hole 440. In the illustrated embodiment, the reinforcing body 510 is formed in a cylindrical shape having a circular cross-section and a length in the front-back direction.

In the above embodiment, the diameter of a cross-section of the reinforcing body 510 may be greater than or equal to the diameter of a cross-section of the tank body penetration hole 440. In addition, the diameter of a cross-section of the reinforcing body 510 may exceed the diameter of a cross-section of the tank cover penetration hole 340.

Accordingly, the reinforcing body 510 may be through-coupled to the tank body penetration hole 440 but not to the tank cover penetration hole 340. Accordingly, one longitudinal end of the reinforcing body 510, the front end in the illustrated embodiment, may support the tank cover surface 310 from the inside, that is, the back side.

The other longitudinal end of the reinforcing body 510, which is the back end in the illustrated embodiment, is coupled to the tank body penetration hole 440 or the tank body boss part 430 in which the tank body penetration hole 440 is formed. The other end of the reinforcing body 510, that is, the back end, may support the tank body surface 410.

The reinforcing body 510 is continuous with the O-ring member coupling part 520.

The O-ring member coupling part 520 is a part where the reinforcing member 500 is through-coupled to the tank cover penetration hole 340. In addition, the O-ring member coupling part 520 is coupled to some components of the fastening part 600, that is, an O-ring member 610 and a washer member 620.

The O-ring member coupling part 520 is at least partially positioned outside the tank body space 420. That is, a part of the O-ring member coupling part 520 is through-coupled to the tank cover penetration hole 340, and the other part of the O-ring member coupling part 520 is exposed outside the tank cover surface 310, which is the front side in the illustrated embodiment.

The O-ring member coupling part 520 is through-coupled to the tank cover penetration hole 340 and may have any shape that can be connected to the O-ring member 610 and the washer member 620. In the illustrated embodiment, the O-ring member coupling part 520 is formed in a cylindrical shape with a circular cross-section and a length in the front-back direction.

In the above embodiment, the diameter of a cross-section of the O-ring member coupling part 520 may be formed to be less than the diameter of a cross-section of the reinforcing body 510, but greater than the diameter of a cross-section of the tank cover penetration hole 340. Accordingly, the O-ring member coupling part 520 may be fitted and coupled into the tank cover penetration hole 340 to close the tank cover penetration hole 340.

Additionally, in the above embodiment, the diameter of a cross-section of the O-ring member coupling part 520 may exceed the diameter of a cross-section of the nut member coupling part 530.

In addition, the extension length of the O-ring member coupling part 520 may be formed to be less than or equal to the sum of the thickness of the tank cover surface 310, the thickness of the O-ring member 610 before shape deformation, and the thickness of the washer member 620, that is, the length in the front-back direction in the illustrated embodiment. Accordingly, the O-ring member 610 may be pressed by the tank cover surface 310 and the reinforcing body 510 and at least partially compressed and may be coupled to the reinforcing member 500. As a result, the coupling force of the fastening part 600 and the reinforcing member 500 may be stably maintained.

One end of the extension direction of the O-ring member coupling part 520, which is the back end in the illustrated embodiment, is continuous with the reinforcing body 510. The other end of the extension direction of the O-ring member coupling part 520, which is the front end in the illustrated embodiment, is continuous with the nut member coupling part 530.

The nut member coupling part 530 is a part where the reinforcing member 500 is coupled to another component of the fastening part 600, that is, a nut member 630. The nut member coupling part 530 is exposed to the outside of the tank body space 420 and may be coupled to the nut member 630.

In one embodiment, the nut member coupling part 530 may be screw-coupled to the nut member 630. In the above embodiment, a screw thread may be formed on the outer periphery of the nut member coupling part 530 to be coupled to the screw thread formed on the inner periphery of the nut member 630.

The nut member coupling part 530 may have a shape corresponding to the shape of the nut member 630. In the illustrated embodiment, the nut member coupling part 530 is formed in a cylindrical shape having a circular cross-section and a length in the front-back direction.

In the above embodiment, the diameter of a cross-section of the nut member coupling part 530 may be less than the diameter of a cross-section of the O-ring member coupling part 520. In addition, the diameter of a cross-section of the nut member coupling part 530 may be greater than the diameter of a cross-section of the snap ring member coupling part 540 or the reinforcing head 550.

One end of the longitudinal direction of the nut member coupling part 530, which is the back end in the illustrated embodiment, is continuous with the O-ring member coupling part 520. The other end of the longitudinal direction of the nut member coupling part 530, which is the front end in the illustrated embodiment, is continuous with the snap ring member coupling part 540.

The snap ring member coupling part 540 is a part where the reinforcing member 500 is coupled to another component of the fastening part 600, that is, a snap ring member 640. The snap ring member coupling part 540 is exposed to the outside of the tank body space 420 and may be coupled to the snap ring member 640.

The snap ring member 640 may be fitted and coupled to the snap ring member coupling part 540. To this end, the snap ring member coupling part 540 may be formed in a shape corresponding to the shape of the snap ring member 640. In the illustrated embodiment, the snap ring member coupling part 540 has a cylindrical shape with a circular cross-section and a length in the front-back direction.

In the above embodiment, the diameter of a cross-section of the snap ring member coupling part 540 may be formed to be less than the diameter of a cross-section of the nut member coupling part 530. In addition, the diameter of a cross-section of the snap ring member coupling part 540 may be formed to be less than or equal to the diameter of a cross-section of the reinforcing head 550.

Therefore, the snap ring member 640 coupled to the snap ring member coupling part 540 may be supported by the nut member coupling part 530 and the reinforcing head 550 along the longitudinal direction of the reinforcing member 500, respectively. Accordingly, the snap ring member 640 may not be moved arbitrarily along the longitudinal direction of the reinforcing member 500.

One side of the longitudinal direction of the snap ring member coupling part 540, which is the back end in the illustrated embodiment, is continuous with the nut member coupling part 530. The other side of the longitudinal direction of the snap ring member coupling part 540, which is the front end in the illustrated embodiment, is continuous with the reinforcing head 550.

The reinforcing head 550 constitutes an end of a part among the ends of the longitudinal direction of the reinforcing member 500 that is exposed to the outside of the tank body space 420. In the illustrated embodiment, the reinforcing head 550 constitutes one side of the longitudinal direction of the reinforcing member 500, that is, a front side end.

The reinforcing head 550 is continuous with the snap ring member coupling part 540. The reinforcing head 550 supports the snap ring member 640 coupled to the snap ring member coupling part 540 on one side of the longitudinal direction, which is the front side in the illustrated embodiment.

The reinforcing head 550 may have a shape corresponding to the shapes of other components of the reinforcing member 500, that is, the reinforcing body 510, the O-ring member coupling part 520, the nut member coupling part 530 and the snap ring member coupling part 540. In the illustrated embodiment, the reinforcing head 550 has a cylindrical shape with a circular cross-section and a length in the front-back direction.

In the above embodiment, the diameter of a cross-section of the reinforcing head 550 may exceed the diameter of a cross-section of the snap ring member coupling part 540, but may be less than the diameter of a cross-section of the O-ring member coupling part 520. By the relationship between the diameters of the cross-sections as described above, the O-ring member coupling part 520, the nut member coupling part 530, the snap ring member coupling part 540 and the reinforcing head 550 may penetrate the tank cover penetration hole 340, but the reinforcing body 510 may not penetrate the tank cover penetration hole 340 and may support the tank cover surface 310 from the inside.

Moreover, as described above, by the relationship between the diameters of the cross-sections as described above, the reinforcing head 550 may support one side of the snap ring member 640.

The fastening part 600 connects the reinforcing member 500 to the tank cover 300. By the fastening part 600, the coupling state of the tank cover 300 and the reinforcing member 500 may be stably maintained.

The fastening part 600 is coupled to the reinforcing member 500. The fastening part 600 is coupled to each of the parts of the reinforcing member 500 that are exposed to the outside of the tank body space 420, that is, the O-ring member coupling member 520, the nut member coupling member 530 and the snap ring member coupling member 540.

The fastening part 600 supports the tank cover 300 from the outside. Specifically, the fastening part 600 is coupled to the outer part of the reinforcing member 500 to support the tank cover surface 310 from the outside, which is the front side in the illustrated embodiment.

That is, the outer side of the tank cover surface 310 may be supported by the fastening part 600, and the inner side (i.e., the back side) of the tank cover surface 310 may be supported by the reinforcing body 510. Therefore, the coupling state of the tank cover 300 and the reinforcing member 500 may be stably maintained.

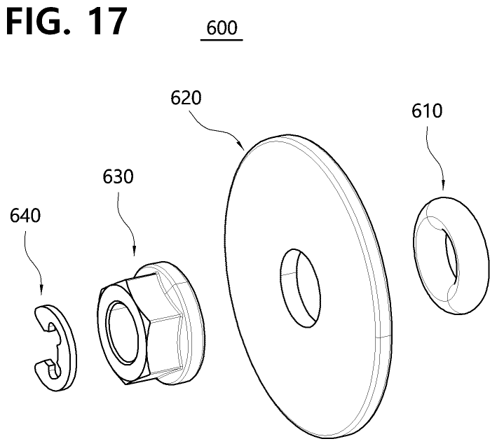

The fastening part 600 may include any configuration that can couple the tank cover 300 and the reinforcing member 500. In the embodiment illustrated in FIG. 17, the fastening part 600 includes an O-ring member 610, a washer member 620, a nut member 630 and a snap ring member 640.

The O-ring member 610 is configured to seal the space between the reinforcing body 510 and the inner side of the tank cover surface 310, which is the back side in the illustrated embodiment. In addition, the O-ring member 610 may seal the space between the tank cover surface 310 and the O-ring member coupling part 520. The O-ring member 610 is positioned in the tank body space 420.

The O-ring member 610 may be deformed by being pressed by one side facing the tank body space 420 among each side of the tank cover surface 310, which is the back side in the illustrated embodiment, and the front side of the reinforcing body 510. The O-ring member 610 may seal the space between the tank cover surface 310 and the reinforcing body 510 by the restoring force stored by the shape deformation.

The O-ring member 610 may be formed of a material having a predetermined elasticity. In one embodiment, the O-ring member 610 may be formed of a rubber or silicone material.

The O-ring member 610 is coupled to the reinforcing member 500. Specifically, the O-ring member 610 is through-coupled to a part of the O-ring member coupling part 520 positioned inside the tank body space 420.

In this case, as described above, the O-ring member coupling part 520 is extended by a length less than or equal to the sum of the thicknesses of the tank cover surface 310, the O-ring member 610 and the washer member 620 before being deformed in shape such that the O-ring member 610 can be maintained in an at least partially compressed state.

The O-ring member 610 is positioned between the tank cover surface 310 and the reinforcing body 510 along the longitudinal direction of the reinforcing member 500. The O-ring member 610 may be compressed by the back side surface of the tank cover surface 310 and the front side surface of the reinforcing body 510.

The O-ring member 610 is coupled to the O-ring member coupling part 520 and may have any shape that can seal the space between the tank cover surface 310 and the reinforcing body 510. In the illustrated embodiment, the O-ring member 610 has a three-dimensional shape with an annular cross-section.

The washer member 620 is configured to disperse the pressure applied from the nut member 630. By the washer member 620, the nut member 630 may prevent damage to the tank cover surface 310 while bringing the reinforcing member 500 into close contact with the tank cover surface 310.

The washer member 620 is coupled to the reinforcing member 500. Specifically, the washer member 620 is through-coupled to another part of the O-ring member coupling part 520 positioned outside the tank body space 420. The washer member 620 is positioned between the tank cover surface 310 and the nut member 630 along the longitudinal direction of the reinforcing member 500.

The washer member 620 supports the tank cover surface 310 from the outside, which is the front side in the illustrated embodiment. The washer member 620 is positioned to face the O-ring member 610 with the tank cover surface 310 therebetween.

The washer member 620 is coupled to the O-ring member coupling part 520 and may have any shape that can disperse the pressure applied from the nut member 630. In the illustrated embodiment, the washer member 620 has a circular cross-section and a thickness in the front-back direction, and is a disc shape with a hollow formed through the inside.

The nut member 630 provides a pressure to adhere the washer member 620 to the outer side of the tank cover surface 310, which is the front side in the illustrated embodiment. By the nut member 630, the washer member 620 may be pressed and adhered toward the tank cover surface 310.

The nut member 630 is coupled to the reinforcing member 500. Specifically, the nut member 630 is through-coupled to the nut member coupling part 530 positioned on the outside of the tank body space 420. The nut member 630 is positioned between the snap ring member 640 and the washer member 620 along the longitudinal direction of the reinforcing member 500.

The nut member 630 may be screw-coupled to the nut member coupling part 530. To this end, a thread may be formed on the inner periphery of the nut member 630 to be coupled to the thread formed on the outer periphery of the nut member coupling part 530.

The nut member 630 applies a pressure toward the tank cover surface 310 to the washer member 620. Accordingly, the washer member 620 may be pressed against the tank cover surface 310.

The nut member 630 supports the washer member 620 from the outside, which is the front side in the illustrated embodiment. The nut member 630 is positioned to face the tank cover surface 310 with the washer member 620 therebetween.

The nut member 630 may be supported by the snap ring member 640. That is, the nut member 630 may be prevented from moving in a direction in which it is separated from the nut member coupling part 530, which is the front side in the illustrated embodiment, by the snap ring member 640 coupled to the snap ring member coupling part 540.

To this end, one side of the nut member 630 in the longitudinal direction, which is the front side in the illustrated embodiment, may be spaced from the snap ring member 640, but may be supported by coming into contact with the snap ring member 640 when it is moved forward by a predetermined distance.

The nut member 630 is coupled to the nut member coupling part 530, applies a pressure toward the tank cover surface 310 to the washer member 620, and may be provided in any form that can prevent arbitrary separation by the snap ring member 640.

In one embodiment, the nut member 630 may be provided in the form of a hard lock nut. In the above embodiment, a hollow is formed inside the nut member 630 for the nut member coupling part 530 to penetrate, and a member for compression, such as nylon, may be provided on the inner periphery of the nut member 630 surrounding the hollow.

The snap ring member 640 supports the nut member 630 on one side of the longitudinal direction of the reinforcing member 500, which is the front side in the illustrated embodiment. The snap ring member 640 is configured to prevent movement and thus arbitrary separation of the nut member 630 coupled with the nut member coupling portion 530.

The snap ring member 640 is coupled to the reinforcing member 500. Specifically, the snap ring member 640 is coupled to the snap ring member coupling part 540 positioned outside the tank body space 420. In one embodiment, the snap ring member 640 may be through-coupled or fitted and coupled to the snap ring member coupling part 540. The snap ring member 640 is positioned between the reinforcing head 550 and the nut member 630 along the longitudinal direction of the reinforcing member 500.

The snap ring member 640 may be coupled to the snap ring member coupling part 540 and may have any shape that is capable of supporting the nut member 630 on one side (i.e., the front side) in the longitudinal direction. In the illustrated embodiment, the snap ring member 640 is formed as a plate shape having an arc-shaped cross-section with a polygonal inner circumference, a left part of which is formed open, and a thickness in the front-back direction.

In the above embodiment, one side of the snap ring member 640 in the thickness direction, which is the front side in the illustrated embodiment, is supported by the reinforcing head 550. The other side of the snap ring member 640 in the thickness direction, which is the back side in the illustrated embodiment, is positioned to be spaced apart from the front side of the nut member 630. When the nut member 630 is moved toward the snap ring member 640 by a predetermined distance, the other side of the snap ring member 640 may come into contact with the nut member 630, thereby preventing further movement of the nut member 630.

Additionally, in the above embodiment, the snap ring member 640 may be moved radially and coupled to the snap ring member coupling part 540. That is, the snap ring member coupling part 540 may be inserted into the space formed inside the snap ring member 640 through the left part which is formed to be open on the outer circumference of the snap ring member 640.

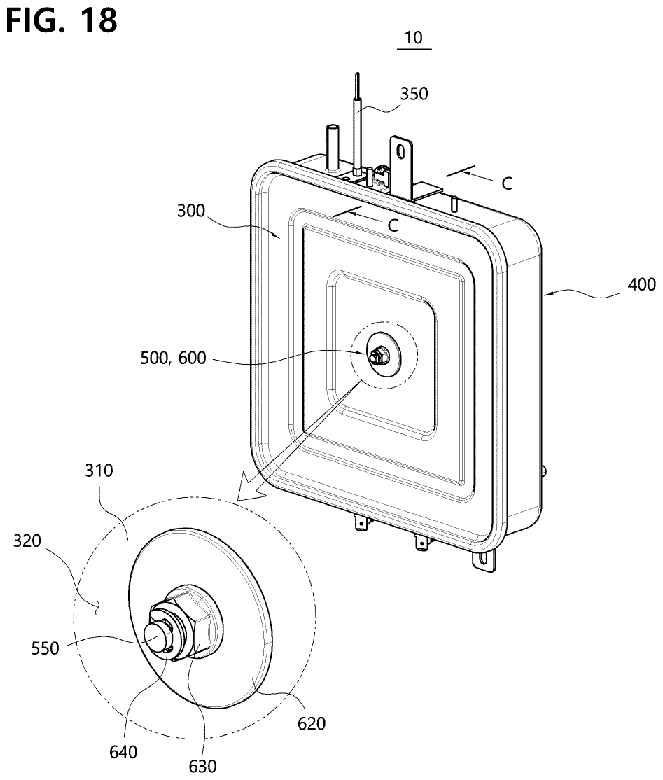

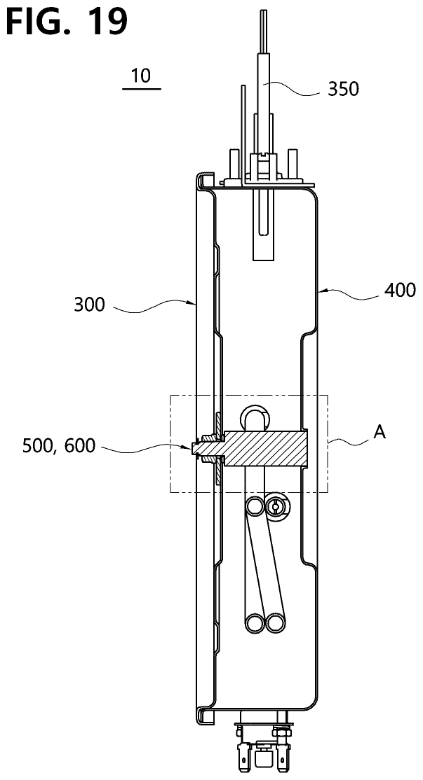

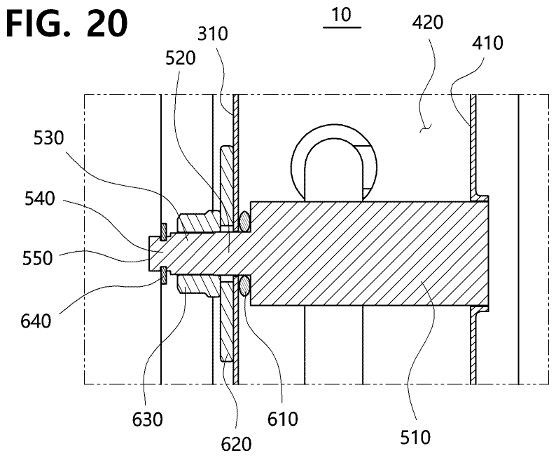

Referring to FIGS. 18 to 20, an example is illustrated in which each component of a water tank 10 according to an embodiment of the present invention is coupled to reinforce the rigidity of the tank cover 300 and the tank body 400. In the illustrated embodiment, the heat insulating member 100 and the sealing member 200 are omitted for the convenience of understanding.

One side of the longitudinal direction of the reinforcing member 500, which is the back side in the illustrated embodiment, is through-coupled to the tank body penetration hole 440. The back end of the reinforcing body 510 is fixedly connected to the inner circumference of the tank body surface 410 surrounding the tank body penetration hole 440 or to the tank body surface 410 itself.

Accordingly, the back end of the reinforcing body 510 may be coupled to the tank body 400 to support the same. Additionally, in the above state, one side in the thickness direction of the tank cover surface 310, which is the back side in the illustrated embodiment, is supported by the front end of the reinforcing body 510.

The other side in the length direction of the reinforcing member 500, which is the front side in the illustrated embodiment, is through-coupled to the tank cover penetration hole 340. In this case, a part of the O-ring member coupling part 520 is positioned in the tank body space 420 or is accommodated in the tank cover penetration hole 340. The other part of the O-ring member coupling part 520 and the nut member coupling part 530, the snap ring member coupling part 540 and the reinforcing head 550 are coupled through the tank cover penetration hole 340 and are positioned on the outside of the tank body space 420.

To this end, the diameter of a cross-section of the tank cover penetration hole 340 is formed to be less than the diameter of a cross-section of the reinforcing body 510 and less than the diameter of a cross-section of the O-ring member coupling part 520, but is formed to exceed the diameters of cross-sections of the nut member coupling part 530, the snap ring member coupling part 540 and the reinforcing head 550, as described above.

The O-ring member 610 is positioned between the tank cover surface 310 and the reinforcing body 510. The O-ring member 610 may seal the space between the tank cover surface 310 and the reinforcing body 510 and maintain the tank cover 300 in a pressurized state toward the tank body 400.

The washer member 620 penetrates the O-ring member coupling part 520 and supports the tank cover surface 310 from the outside, that is, the front side.

Next, the nut member 630 penetrates the nut member coupling part 530 to support the washer member 620 from the outside, that is, the front side. In this case, the nut member 630 may press the washer member 620 such that the O-ring member 610 is at least partially deformed and positioned between the tank cover surface 310 and the reinforcing body 510.

To this end, as described above, the length of the O-ring member coupling part 520 is formed to be less than the sum of the thickness of the tank cover surface 310, the thickness of the O-ring member 610 before being deformed, and the thickness of the washer member 620.

In addition, the nut member 630 may press the washer member 620 to a position where the outer side in the longitudinal direction, that is, the front side end is separated from the snap ring member coupling part 540.

Next, the snap ring member 640 is coupled to the snap ring member coupling part 540 to support the nut member 630 from the outside, that is, the front side. When the nut member 630 is not moved, the snap ring member 640 may be positioned to be spaced apart from the nut member 630. At the same time, one side in the thickness direction of the snap ring member 640, that is, the front side, may be supported by the reinforcing head 550.

By the above-described coupling, the coupling of the reinforcing member 500 and the tank cover 300 may be stably maintained. Accordingly, the rigidity of the tank cover 300 and the tank body 400 is reinforced by the reinforcing member 500 such that the pressure resistance against the fluid flowing in the tank body space 420 can be improved.

Specifically, the tank cover 300 may not expand outwardly, that is, toward the front side, in response to an increase in pressure, or contract inwardly, that is, toward the back side, in response to a decrease in pressure. In addition, the tank body 400 may also expand outwardly, that is, toward the back side, in response to an increase in pressure, or contract inwardly, that is, toward the front side, in response to a decrease in pressure.

Furthermore, as described above, the tank cover surface 310 may be formed with a tank cover recessed part 320 and a tank cover boss part 330 such that the tank cover surface 310 may be formed at least partially with a rough surface. Similarly, the tank body surface 410 may also be formed with a tank body boss part 430 and a tank body recessed part 450 such that the tank body surface 410 may be formed at least partially with a rough surface.

Therefore, the rigidity of the tank cover 300 and the tank body 400 of the water tank 10 according to an embodiment of the present disclosure may be reinforced by the reinforcing member 500. At the same time, the rigidity of the tank cover 300 and the tank body 400 may also be reinforced by the roughness formed on the tank cover 300 and the tank body 400 themselves.

According to the water tank 10 according to an embodiment of the present disclosure described above, the volume of the water tank 10 may be maintained regardless of the internal pressure change due to the fluid flowing in or out.

Therefore, the water tank 10 according to an embodiment of the present disclosure may enable the quantitative extraction and constant temperature extraction of a fluid.

Specifically, the flow rate of a fluid provided from the water purifier (not illustrated) to the outside may be adjusted in accordance with the time for which the extraction valve (not illustrated) coupled to the water tank 10 is maintained in an open state.

Similarly, the temperature of a fluid provided from the water purifier (not illustrated) to the outside may be adjusted in accordance with the amount of hot or cold water flowing out from the water tank 10 while the extraction valve (not illustrated) coupled to the water tank 10 is maintained in an open state.

In this case, if the tank cover 300 or the tank body 400 constituting the water tank 10 is contracted or expanded while the extraction valve (not illustrated) is open, there is a concern that the fluid may be extracted in excess or insufficiently as much as the contracted or expanded volume.

In order to prevent this, as described above, the water tank 10 according to an embodiment of the present disclosure may prevent deformation of the shape of the water tank 10 while a fluid flows into or out of the water tank 10. Accordingly, the amount of a fluid flowing out while the extraction valve (not illustrated) is open may be adjusted to a constant level.

As a result, the fluid provided to the outside may be provided in a constant amount and at a constant temperature at the same time.

Although the embodiments of the present disclosure have been described, the spirit of the present disclosure is not limited to the embodiments presented in this specification, and those skilled in the art who understand the spirit of the present disclosure will be able to easily suggest other embodiments by modifying, changing, deleting or adding components within the scope of the same spirit, but this will also be considered to fall within the spirit of the present disclosure.

What is claimed is:

1. A water tank, comprising:
a tank body having a tank body space formed therein;
a tank cover configured to cover the tank body space and be coupled to the tank body;
a reinforcing member that is at least partially accommodated in the tank body space and is respectively coupled to the tank body and the tank cover to reinforce rigidity of the tank body or the tank cover; and
a fastening part configured to couple the reinforcing member and the tank cover.

2. The water tank of claim 1, wherein the tank body comprises a tank body surface that surrounds the tank body space on one side opposite to the tank cover, and
wherein the reinforcing member extends between the tank body surface and the tank cover and is respectively coupled to the tank body surface and the tank cover.

3. The water tank of claim 2, wherein one end of an extension direction of the reinforcing member is fixedly coupled to the tank body surface.

4. The water tank of claim 2, wherein the reinforcing member comprises:
a reinforcing body accommodated in the tank body space, one end of which in an extension direction is coupled to the tank body surface; and
a reinforcing head that is continuous with the other end of an extension direction of the reinforcing body, and is exposed to the outside of the tank body space and is arranged to face the tank body space with the tank cover interposed therebetween.

5. The water tank of claim 4, wherein the tank cover comprises:
a tank cover surface configured to cover the tank body space; and
a tank cover penetration hole positioned inside the tank cover surface and formed through the extension direction of the reinforcing body, through which the reinforcing member is penetrated and coupled.

6. The water tank of claim 5, wherein the tank cover comprises:
a tank cover recessed part formed to be recessed on the tank cover surface toward the tank body space; and
a tank cover boss part positioned in the tank cover recessed part and formed to protrude in a direction opposite to the tank body space.

7. The water tank of claim 4, wherein the reinforcing member comprises:
an O-ring member coupling part that is continuous with the other end of the extension direction of the reinforcing body and penetrates the tank cover;
a nut member coupling part that is continuous with the O-ring member coupling part and is coupled to the fastening part; and
a snap ring member coupling part that is continuous with the nut member coupling part and the reinforcing head, respectively, and is coupled to the fastening part.

8. The water tank of claim 7, wherein the fastening part is through-coupled to the O-ring member coupling part, and comprises an O-ring member configured to seal between the O-ring member coupling part and the tank cover.

9. The water tank of claim 7, wherein the fastening part comprises:
a washer member that is through-coupled to the O-ring member coupling part and is disposed to face the tank body space with the tank cover interposed therebetween; and
a nut member that is through-coupled to the nut member coupling part and is disposed to face the tank cover with the washer member interposed therebetween.

10. The water tank of claim 9, wherein the nut member is provided as a hard lock nut.

11. The water tank of claim 7, wherein the fastening part comprises a snap ring member that is coupled to the snap ring member coupling part, and is configured to prevent loosening of a nut member that is coupled to the nut member coupling part.

12. The water tank of claim 11, wherein the diameter of a cross-section of the snap ring member coupling part is formed to be less than the diameter of a cross-section of the nut member coupling part and the diameter of a cross-section of the reinforcing head.
